(19) United States
(12) Patent Application Publication
(10) Pub. No.: US 2024/0391099 A1
(43) Pub. Date: Nov. 28, 2024

(54) ROBOT CONTROL DEVICE AND ROBOT SYSTEM

(71) Applicant: FANUC CORPORATION, Yamanashi (JP)

(72) Inventor: Takashi SATOU, Yamanashi (JP)

(73) Assignee: FANUC CORPORATION, Yamanashi (JP)

(21) Appl. No.: 18/694,343

(22) PCT Filed: Oct. 11, 2021
(86) PCT No.: PCT/JP2021/037587

§ 371 Date: Mar. 21, 2024

(51) Int. Cl. B25J 9/16

(52) U.S. Cl. CPC B25J 9/1653

(57) ABSTRACT

Provided are a robot control device and a robot system that can automatically correct errors in position and posture when supplying a workpiece. A robot control device for controlling a robot comprises an error correction unit that, when the robot supplies a workpiece to or removes the workpiece from a machine tool, performs force control on the basis of a detection value of a force detector detecting an external force and a moment acting on the workpiece, and corrects errors in position and posture of the workpiece and a securing mechanism securing the workpiece.

### TECHNICAL FIELD

The present invention relates to a robot control device and a robot system.

### BACKGROUND ART

Conventionally, a robot is used to supply a workpiece to industrial equipment such as a machine tool. In this case, the robot grips the workpiece and supplies the gripped workpiece to the securing mechanism of the spindle of the machine tool. As the securing mechanism for securing the workpiece, for example, a chuck having about 2 to 4 claws or a mechanism for holding the workpiece by suction with air is used (for example, see Patent Document 1).

### CITATION LIST

### Patent Document

Patent Document 1: Japanese Unexamined Patent Application, Publication No. 2020-59069

### DISCLOSURE OF THE INVENTION

### Problems to be Solved by the Invention

To obtain sufficient machining accuracy with a machine tool, the center position of the workpiece and the center position defined by the claws must coincide with each other, and the workpiece must be supplied parallel to the direction of the claws. To realize such an operation by the robot, it is necessary to perform teaching work for matching the center position and the posture of the workpiece with the securing mechanism. Accurate teaching requires a lot of time and effort, even for skilled workers, and is very difficult for workers unfamiliar with the robot.

Therefore, there is a demand for a robot control device and a robot system capable of automatically correcting errors in position and posture when a workpiece is supplied.

### Means for Solving the Problems

A robot control device according to one aspect of the present disclosure is a robot control device for controlling a robot, including an error correction unit that, when the robot supplies a workpiece to or removes the workpiece from a machine tool, performs force control based on a detection value of a force detector for detecting an external force and a moment acting on the workpiece, and corrects errors in position and posture between the workpiece and a securing mechanism for securing the workpiece.

A robot system according to one aspect of the present disclosure includes a robot for supplying a workpiece to or removing the workpiece from a machine tool, a gripping mechanism provided in the robot and configured to grip the workpiece, a securing mechanism provided in the machine tool and configured to secure the workpiece, a force detector configured to detect an external force and a moment acting on the workpiece, and a robot control device configured to control the robot. The robot control device includes an error correction unit that, when the robot supplies the workpiece to or removes the workpiece from the machine tool, performs force control based on a detection value of the force detector, and corrects errors in position and posture between the workpiece and the securing mechanism.

### Effects of the Invention

According to the present invention, errors in position and posture can be automatically corrected when a workpiece is supplied.

### BRIEF DESCRIPTION OF THE DRAWINGS

FIG. 1 is a block diagram showing the configuration of a robot system according to the present embodiment;

FIG. 2A shows an operation when a workpiece is secured to a securing mechanism according to the present embodiment;

FIG. 2B shows an operation when the workpiece is secured to the securing mechanism according to the present embodiment;

FIG. 3A shows an operation of correcting an error in the posture of the workpiece;

FIG. 3B shows an operation of correcting an error in the posture of the workpiece;

FIG. 3C shows an operation of correcting an error in the posture of the workpiece;

FIG. 4A shows an operation of correcting an error in the position of the workpiece; and

FIG. 4B shows an operation of correcting an error in the position of the workpiece.

### PREFERRED MODE FOR CARRYING OUT THE INVENTION

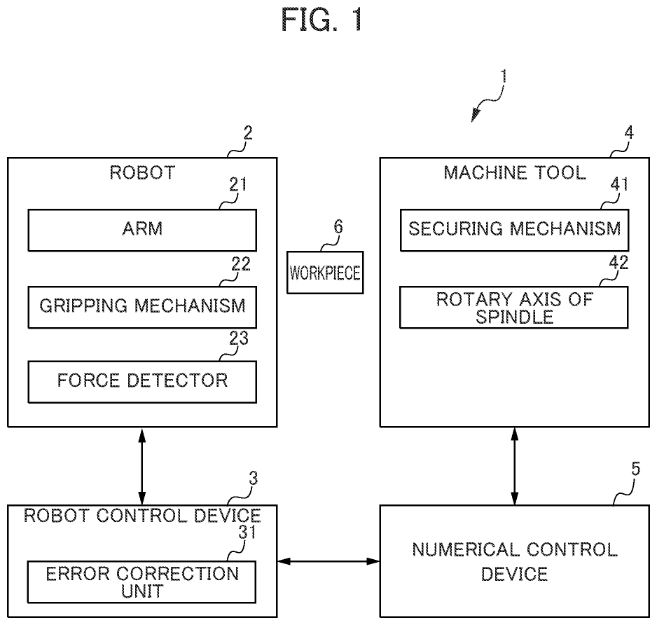

Hereinafter, an embodiment of the present invention will be described. FIG. 1 is a block diagram showing the configuration of a robot system 1 according to the present embodiment. In the robot system 1 according to the present embodiment, a robot 2 supplies a workpiece 6 to a machine tool 4, and the machine tool 4 machines the supplied workpiece 6. Then, the robot 2 removes the machined workpiece 6 from the machine tool 4. As shown in FIG. 1, the robot system 1 includes the robot 2, a robot control device 3, the machine tool 4, and a numerical control device 5.

The robot 2 is, for example, an articulated robot, and operates under the control of the robot control device 3. The robot 2 supplies the workpiece 6 to the machine tool 4, and removes the machined workpiece 6 from the machine tool 4. The robot 2 includes an arm 21, a gripping mechanism 22, and a force detector 23.

The arm 21 is, for example, an articulated arm, and supplies the workpiece 6 to the machine tool 4 or removes the workpiece 6 from the machine tool 4 in a state where the workpiece 6 is gripped by the gripping mechanism 22. The gripping mechanism 22 and the force detector 23 are attached to the leading end part of the arm 21.

The gripping mechanism 22 is attached to the leading end part of the arm 21 and grips the workpiece 6. The force detector 23 is provided, for example, in the vicinity of the gripping mechanism 22, and detects an external force and a moment acting on the workpiece 6. The force detector 23 may be, for example, a six-axis force sensor that detects at least one of an external force or a moment acting on the workpiece 6. Alternatively, the force detector 23 may be a torque sensor provided on each axis of the robot 2, or may estimate torque from a current value of a motor provided on each axis of the robot 2.

The robot control device 3 and the numerical control device 5 are each a computer including hardware such as an arithmetic processing device such as a CPU (central processing unit), an auxiliary storage device such as an HDD (hard disk drive) or SSD (solid state drive) that stores various programs, and a main storage device such as a RAM (random access memory) that stores data temporarily required for the arithmetic processing device to execute a program, an operating device such as a keyboard for the operator to perform various operations, and a display device such as a display that displays various information to the operator.

The robot control device 3 includes an error correction unit 31 as a functional unit of the arithmetic processing device. The error correction unit 31 performs force control based on the detection value of the force detector 23 when the robot 2 supplies the workpiece 6 to or removes the workpiece 6 from the machine tool 4, and corrects errors in the position and posture between the workpiece 6 and the securing mechanism 41.

The machine tool 4 machines the workpiece 6 supplied by the robot 2. The machine tool 4 executes a machining operation on the workpiece 6, an opening/closing operation of the securing mechanism 41 for gripping the workpiece 6, a rotation operation of a rotary axis 42 of the spindle, and the like in accordance with various command signals transmitted from the numerical control device 5. The machine tool 4 is, for example, a lathe, a ball mill, a milling machine, a grinding machine, a laser machine, an injection molding machine, or the like, but is not limited thereto. Alternatively, the robot system 1 may use other industrial equipment capable of securing a workpiece instead of the machine tool 4.

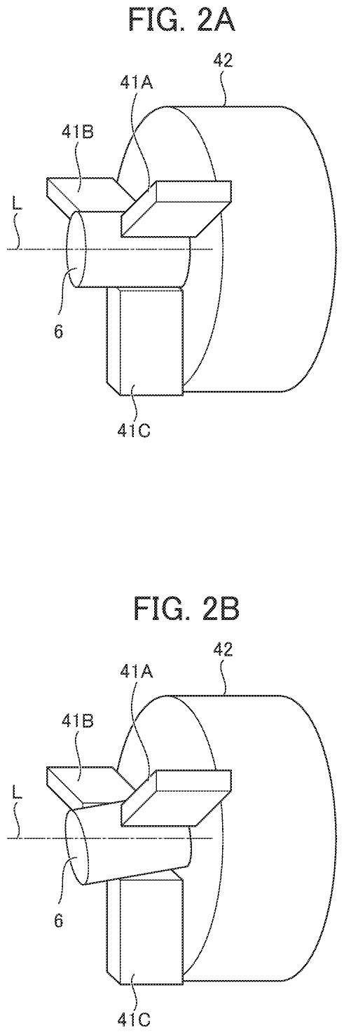

FIGS. 2A and 2B each show an operation when the workpiece 6 is secured to the securing mechanism 41 according to the present embodiment. As shown in FIGS. 2A and 2B, in the present embodiment, the machine tool 4 holds the cylindrical workpiece 6 using a chuck as the securing mechanism 41. Claws 41A, 41B, and 41C of the chuck open and close in the radial direction of the rotary axis 42 of the spindle to hold and release the workpiece 6.

In the present embodiment, the chuck having three claws 41A, 41B, and 41C is used as the securing mechanism 41 in the machine tool 4, but a chuck having, for example, less than three or four or more claws may be used, or a suction mechanism that holds the workpiece 6 by suction to the rotary axis 42 of the spindle may be used.

When supplying the workpiece 6 to the securing mechanism 41, the robot 2 moves along a direction L in which the workpiece 6 is supplied to the securing mechanism 41. Then, when the robot 2 supplies the cylindrical workpiece 6 to the vicinity of the center position defined by the claws 41A, 41B, and 41C, and the machine tool 4 closes the claws 41A, 41B, and 41C, the workpiece 6 is secured to the center position of the rotary axis 42 of the spindle.

If the workpiece 6 can be supplied to the rotary axis 42 of the spindle at the correct position and posture, the rotary axis 42 of the spindle coincides with the central axis of the workpiece 6 when the claws 41A, 41B, and 41C are closed, as shown in FIG. 2A. In this case, the machine tool 4 can obtain good machining accuracy.

However, when supplying the workpiece 6, if there are large errors in the position and posture of the workpiece 6 with respect to the rotary axis 42 of the spindle, the workpiece 6 may be secured in a state where the rotary axis 42 of the spindle and the central axis of the workpiece 6 are misaligned with each other as shown in FIG. 2B when the claws 41A, 41B, and 41C are closed. In this case, the machine tool 4 cannot obtain good machining accuracy.

Accordingly, the robot system 1 according to the present embodiment corrects errors in the position and posture between the workpiece 6 and the securing mechanism 41 as described below.

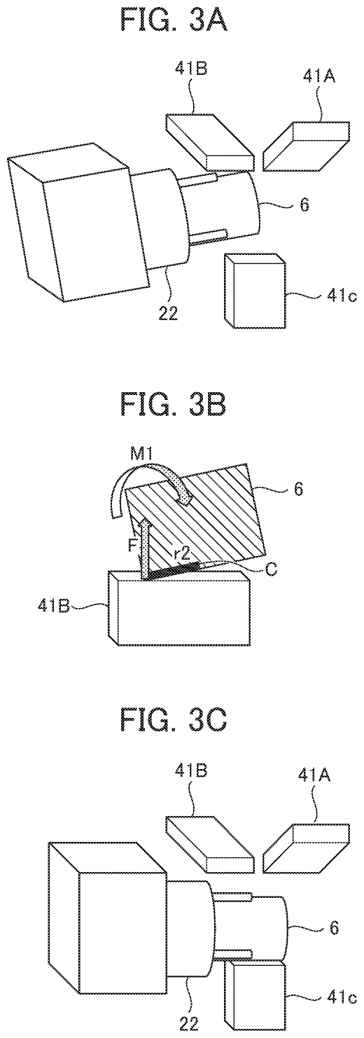

FIGS. 3A, 3B, and 3C each show an operation of correcting an error in the posture of the workpiece 6. As shown in FIG. 3A, the robot control device 3 controls the robot 2 to position the workpiece 6 on the rotary axis 42 of the spindle. In the example shown in FIG. 3A, the workpiece 6 has an error in posture with respect to the rotary axis 42 of the spindle. After that, the error correction unit 31 of the robot control device 3 executes force control.

Specifically, the error correction unit 31 controls the robot 2 to press the workpiece 6 against any one of the claws 41A, 41B, and 41C during the force control. That is, the error correction unit 31 causes the robot 2 to press the workpiece 6 against the securing mechanism 41 in a direction substantially orthogonal to the direction in which the workpiece 6 is supplied to the securing mechanism 41 during the force control.

FIG. 3B shows an operation of correcting the posture of the workpiece 6 when the workpiece 6 is pressed against the claw 41B. As shown in FIG. 3B, when the robot 2 presses the workpiece 6 against the claw 41B, a moment M1 is generated around the center (rotation center C) of the contact surface between the workpiece 6 and the claw 41B. Here, assuming that a reaction force with respect to a force of pressing the workpiece 6 against the claw 41B is a force F, and a distance from the rotation center C of the workpiece 6 to a position where the force F acts is a distance r2, the moment M1 is expressed as:

$$M 1 = r 2 \times F$$

When the force detector 23 detects the moment M1, the error correction unit 31 performs force control so that the moment for pressing the workpiece 6 against the securing mechanism 41 becomes 0. That is, when the force detector 23 detects the moment M1, the error correction unit 31 causes the robot 2 to rotate the workpiece 6 about the rotation center C to correct the posture of the workpiece 6. As a result, as shown in FIG. 3C, the workpiece 6 rotates in a direction in which the moment M1 decreases, and an error in the posture of the workpiece 6 is corrected.

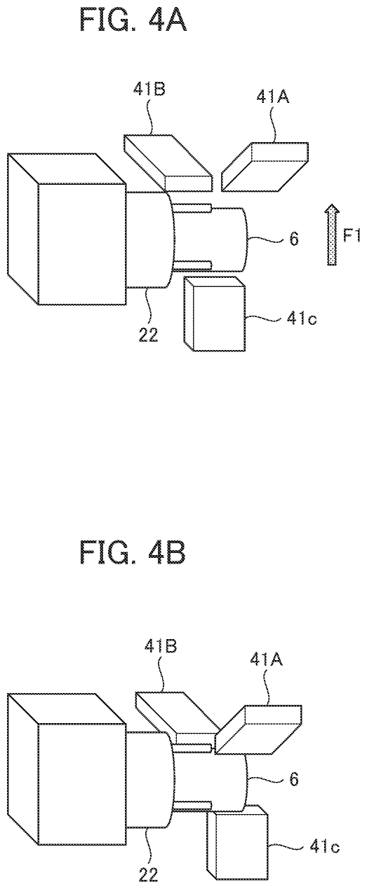

FIGS. 4A and 4B each show an operation of correcting an error in the position of the workpiece 6. As shown in FIG. 4A, the robot control device 3 controls the robot 2 to position the workpiece 6 on the rotary axis 42 of the spindle. In the example shown in FIG. 4A, the workpiece 6 has an error in position with respect to the rotary axis 42 of the spindle. After that, the error correction unit 31 executes force control.

Specifically, the error correction unit 31 transmits a control signal to the numerical control device 5 during the force control, and causes the machine tool 4 to perform an operation of closing the claws 41A, 41B, and 41C of the securing mechanism 41. That is, the numerical control device 5 operates the securing mechanism 41 in conjunction with the force control by the robot 2 and the robot control device 3.

As shown in FIG. 4B, when the claws 41A, 41B, and 41C are closed, the workpiece 6 receives a force F1 from the claws 41A, 41B, and 41C in a direction substantially orthogonal to the direction in which the workpiece 6 is supplied to the securing mechanism 41. When the force detector 23 detects the force F1, the error correction unit 31 moves the workpiece 6 in a direction in which the force F1 decreases by the action of the force control, thereby correcting the position of the workpiece 6.

When the claws 41A, 41B, and 41C are closed during the force control as described above, when an error in position occurs in the workpiece 6, the workpiece 6 moves in a direction to eliminate the error in position by the action of the force control. The force control described above is, for example, impedance control, damping control, or the like, but is not limited thereto.

The machine tool 4 may repeat the operation of the securing mechanism 41 a preset number of times. For example, when the securing mechanism 41 is a chuck, the machine tool 4 repeats opening and closing of the chuck a predetermined number of times while performing force control. Thus, every time the chuck is opened or closed, errors in the position and posture of the workpiece 6 are corrected. When the securing mechanism 41 is a suction mechanism, the machine tool 4 repeats turning on and off of the air of the suction mechanism a predetermined number of times during the force control. Thus, every time the air is turned on/off, errors in the position and posture of the workpiece 6 are corrected.

The robot 2 or the machine tool 4 may include a displacement detector that detects the displacement of the workpiece. The error correction unit 31 may repeat force control until the displacement of the workpiece 6, due to operation of the securing mechanism 41, becomes equal to or less than a predetermined distance or a predetermined angle.

Furthermore, when an excessive force and/or moment is generated during operation of the securing mechanism 41, the machine tool 4 may cause the securing mechanism 41 to release the workpiece 6, then operate the securing mechanism 41 again, and cause the securing mechanism 41 to secure the workpiece 6. That is, when the securing mechanism 41 operates, if the detection value of the force detector 23 is equal to or greater than a predetermined value indicating an excessive force and/or moment, the machine tool 4 may suspend the operation of the securing mechanism 41, cause the securing mechanism 41 to release the workpiece 6, then operate the securing mechanism 41 again, and cause the securing mechanism 41 to secure the workpiece 6.

The force detector 23 may be a six-axis force sensor or a three-axis force sensor that detects at least one of an external force or a moment acting on the workpiece 6. The six-axis force sensor can detect forces in the X, Y, and Z directions and moments around the X, Y, and Z axes. The three-axis force sensor may be capable of detecting forces in the X, Y, and Z directions, for example, or may be capable of detecting a force in the Z direction, as well as moments around the X and Y axes.

The force detector 23 may include a torque sensor provided on each axis of the robot 2. The robot control device 3 may calculate at least one of an external force or a moment acting on the workpiece 6 based on a value detected by the torque sensor.

The force detector 23 may include a motor provided on each axis of the robot 2. The robot control device 3 may estimate at least one of an external force or a moment acting on the workpiece 6 based on a current value output from the motor.

In the above-described embodiment, the robot system 1 performs the operation of closing the securing mechanism 41 after pressing the workpiece 6 against the securing mechanism 41, but the robot system 1 may perform the operation of pressing the workpiece 6 after closing the securing mechanism 41.

As described above, according to the present embodiment, the robot system 1 includes the robot 2 for supplying the workpiece 6 to or removing the workpiece 6 from the machine tool 4, the gripping mechanism 22 provided in the robot 2 and configured to grip the workpiece 6, the securing mechanism 41 provided in the machine tool 4 and configured to secure the workpiece 6, the force detector 23 configured to detect an external force and a moment acting on the workpiece 6, and the robot control device 3 configured to control the robot 2. The robot control device 3 includes the error correction unit 31 that, when the robot 2 supplies the workpiece 6 to or removes the workpiece 6 from the machine tool 4, performs force control based on a detection value of the force detector 23, and corrects errors in position and posture between the workpiece 6 and the securing mechanism 41.

Thus, even if errors in the position and posture of the workpiece 6 occur when the workpiece 6 is supplied to or removed from the machine tool 4, the robot system 1 can automatically correct the errors in the position and posture of the workpiece 6 by the action of the force control. Therefore, the user of the robot system 1 can easily teach the position and posture (centering) of the workpiece 6 even when the user is unfamiliar with the setting of the robot system 1.

The force control includes causing the robot 2 to press the workpiece 6 against the securing mechanism 41 in a direction orthogonal to the direction in which the workpiece 6 is supplied to the securing mechanism 41. Thus, the robot system 1 can rotate the workpiece 6 in a direction in which the moment M1 decreases by the action of the force control and correct the posture of the workpiece 6.

The securing mechanism 41 is a chuck or a suction mechanism provided on the spindle of the machine tool 4. Thus, the robot system 1 can appropriately secure the workpiece 6 and machine the workpiece 6.

The machine tool 4 may repeat the operation of the securing mechanism 41 a preset number of times. The error correction unit 31 may repeat the force control until the displacement of the workpiece 6, due to operation of the securing mechanism 41, becomes equal to or less than a predetermined distance or a predetermined angle. Thus, the robot system 1 can appropriately correct errors in the position and posture of the workpiece 6.

When the securing mechanism 41 operates, if the detection value of the force detector 23 is equal to or greater than a predetermined value indicating an excessive force and/or moment, the machine tool 4 may suspend the operation of the securing mechanism 41, cause the securing mechanism 41 to release the workpiece 6, then operate the securing mechanism 41 again, and cause the securing mechanism 41 to secure the workpiece 6. Thus, the robot system 1 can correct the position and posture of the workpiece 6 to an appropriate position and posture.

The force detector 23 may be a six-axis force sensor that detects at least one of an external force or a moment acting on the workpiece 6. The force detector 23 may include a torque sensor provided on each axis of the robot 2. The robot control device 3 may calculate at least one of an external force or a moment acting on the workpiece 6 based on a value detected by the torque sensor. The force detector 23 may include a motor provided on each axis of the robot 2. The robot control device 3 may estimate at least one of an external force or a moment acting on the workpiece 6 based on a current value output from the motor. Thus, the robot system 1 can appropriately detect the external force and the moment acting on the workpiece 6.

The machine tool 4 operates the securing mechanism 41 in conjunction with the force control. Thus, the robot system 1 can automatically correct errors in the position and posture of the workpiece 6 by performing force control using the operation of the securing mechanism 41.

The securing mechanism 41 includes a chuck that is provided on the spindle of the machine tool 4 and that has a plurality of the claws 41A, 41B, and 41C. The error correction unit 31 causes the robot 2 to press the workpiece 6 against one of the plurality of the claws 41A, 41B, and 41C in a direction orthogonal to the direction in which the workpiece 6 is supplied to the chuck, rotates the workpiece 6 in a direction in which the moment M1 generated in the workpiece 6 decreases, corrects an error in the posture of the workpiece 6, causes the machine tool 4 to close the plurality of the claws 41A, 41B, and 41C, moves the workpiece 6 in a direction in which the force F1 generated on the workpiece 6 decreases, and corrects the position of the workpiece 6. Thus, the robot system 1 can correct the error in the position of the workpiece 6 after correcting the error in the posture of the workpiece 6.

The embodiment of the present invention has been described above. The above-described robot system 1 can be implemented by hardware, software, or a combination thereof. The control method performed by the robot system 1 can also be implemented by hardware, software, or a combination thereof. Here, “implemented by software” means that it is implemented by a computer reading and executing a program.

The program may be stored and provided to a computer using various types of non-transitory computer-readable media. The non-transitory computer-readable media include various types of tangible storage media. Examples of the non-transitory computer-readable media include magnetic recording media (e.g., hard disk drives), magneto-optical recording media (e.g., magneto-optical disks), CD-ROMs (read only memories), CD-Rs, CD-R/Ws, semiconductor memories (e.g., mask ROMs, PROMs (programmable ROMs), EPROMs (erasable PROMs), flash ROMs, and RAMs (random access memories)).

Although the above-described embodiments are preferred embodiments of the present invention, the scope of the present invention is not limited to the above-described embodiments, and various modifications can be made without departing from the gist of the present invention.

### EXPLANATION OF REFERENCE NUMERALS

1 robot system
2 robot
3 robot control device
4 machine tool
5 numerical control device
21 arm
22 gripping mechanism
23 force detector
31 error correction unit
41 securing mechanism
42 rotary axis of spindle

1. A robot control device for controlling a robot, comprising:
an error correction unit that, when the robot supplies a workpiece to or removes the workpiece from a machine tool, performs force control based on a detection value of a force detector for detecting an external force and a moment acting on the workpiece, and corrects errors in position and posture between the workpiece and a securing mechanism for securing the workpiece.

2. The robot control device according to claim 1, wherein the force control comprises causing the robot to press the workpiece against the securing mechanism in a direction orthogonal to a direction in which the workpiece is supplied to the securing mechanism.

3. A robot system comprising:
a robot for supplying a workpiece to or removing the workpiece from a machine tool;
a gripping mechanism provided in the robot and configured to grip the workpiece;
a securing mechanism provided in the machine tool and configured to secure the workpiece;
a force detector configured to detect an external force and a moment acting on the workpiece; and
a robot control device configured to control the robot,
the robot control device comprising an error correction unit that, when the robot supplies the workpiece to or removes the workpiece from the machine tool, performs force control based on a detection value of the force detector, and corrects errors in position and posture between the workpiece and the securing mechanism.

4. The robot system according to claim 3, wherein the force control comprises causing the robot to press the workpiece against the securing mechanism in a direction orthogonal to a direction in which the workpiece is supplied to the securing mechanism.

5. The robot system according to claim 3, wherein the securing mechanism comprises a chuck or a suction mechanism provided on a spindle of the machine tool.

6. The robot system according to claim 3, wherein the machine tool repeats operation of the securing mechanism a preset number of times.

7. The robot system according to claim 3, wherein the error correction unit repeats the force control until displacement of the workpiece, due to operation of the securing mechanism, becomes equal to or less than a predetermined distance or a predetermined angle.

8. The robot system according to claim 3, wherein the machine tool suspends operation of the securing mechanism when the detection value of the force detector is equal to or greater than a predetermined value when the securing mechanism operates.

9. The robot system according to claim 3, wherein the force detector comprises a force sensor for detecting at least one of the external force or the moment acting on the workpiece.

10. The robot system according to claim 3,
wherein the force detector comprises a torque sensor provided on each axis of the robot, and
wherein the robot control device calculates at least one of the external force or the moment acting on the workpiece based on a value detected by the torque sensor.

11. The robot system according to claim 3,
wherein the force detector comprises a motor provided on each axis of the robot, and
wherein the robot control device estimates at least one of the external force or the moment acting on the workpiece based on a current value output from the motor.

12. The robot system according to claim 3, wherein the machine tool operates the securing mechanism in conjunction with the force control.

13. The robot system according to claim 3,
wherein the securing mechanism comprises a chuck that is provided on a spindle of the machine tool and that has a plurality of claws,
wherein the error correction unit, in the force control,
causes the robot to press the workpiece against one of the plurality of claws in a direction orthogonal to a direction in which the workpiece is supplied to the chuck,
rotates the workpiece in a direction in which a moment generated in the workpiece decreases and corrects an error in posture of the workpiece,
causes the machine tool to close the plurality of claws of the chuck, and
moves the workpiece in a direction in which a force generated on the workpiece decreases and corrects a position of the workpiece.
